(19) United States
(12) Patent Application Publication
(10) Pub. No.: US 2026/0141202 A1
(43) Pub. Date: May 21, 2026

(54) IMAGE FORMING SYSTEM, AND METHOD AND PROGRAM FOR EXECUTING ALTERNATIVE PROCESSING

(71) Applicant: Konica Minolta, Inc., Tokyo (JP)

(72) Inventor: Shin IGAWA, Tokyo (JP)

(21) Appl. No.: 19/395,077

(22) Filed: Nov. 20, 2025

(30) Foreign Application Priority Data
Nov. 20, 2024 (JP) 2024-202695

(51) Int. Cl. G06K 15/02; G06K 15/10; H04N 1/60

(52) U.S. Cl. CPC G06K 15/186; G06K 15/102; G06K 15/1809; G06K 15/1897; H04N 1/6036

(57) ABSTRACT

An image forming system including: RIP unit configured to perform RIP on data to be printed; a print instruction unit configured to instruct an image forming device to print RIP data; a delay detection unit configured to detect a page for which the RIP is delayed during on-the-fly printing that starts printing without waiting for completion of the RIP of a print job; and an alternative processing instruction unit configured to cause the image forming device to interrupt printing of the page and to execute an alternative processing.

### REFERENCE TO RELATED APPLICATIONS

The present invention claims priority under 35 U.S.C. § 119 to Japanese patent application No. 2024-202695 filed on Nov. 20, 2024, the entire contents of which being incorporated herein by reference.

### BACKGROUND OF THE INVENTION

### Technical Field

The present invention relates to an image forming system, and a method and a program for executing an alternative processing.

### Background Art

In an image forming device, on-the-fly printing has become common, in which printing is started without waiting for completion of raster image processing (RIP) of all pages included in a print job.

During the on-the-fly printing, there is a case in which the RIP for a specific page is delayed. In such a case, the image forming device interrupts the printing of the page while continuing the RIP of the specific page and waits until the RIP is completed and RIP data is transferred to resume the printing after the RIP data arrives.

For example, an image forming device described in Japanese Unexamined Patent Publication No. 2017-213728, in a case in which image data formation is delayed, cancels printing of the corresponding page to allow a blank sheet to pass, and automatically changes a printing order of the following pages, so as to continue the printing by a printing engine.

In this case, although the printing by the engine does not stop, the blank sheets continue to be inserted into the output papers until the RIP is completed.

### SUMMARY OF INVENTION

### Technical Problem

The image forming device described in the Japanese Unexamined Patent Publication No. 2017-213728, when determining that image data is not in time, skips the processing of image formation to set a blank sheet and changes the printing order determined in advance in order not to stop the printing.

Therefore, in a case in which the image data is not in time, unnecessary blank sheets are continuously inserted.
As a result, the image forming device described in Japanese Unexamined Patent Publication No. 2017-213728 fails to effectively use the waiting time until the RIP is completed in a case in which the RIP for a certain page is delayed to cause the printing to be interrupted in the on-the-fly printing.

The present invention has been made in consideration of the above-described problem and it is an object to utilize the waiting time, when the RIP for a certain page is delayed to cause the printing of the page to be interrupted in the on-the-fly printing, until the RIP is completed and the printing of the page is restarted.

### Solution to Problem

The above-described object is solved by the following solutions according to one aspect of the present invention, which includes the following configuration to solve the above-described problem.

An image forming system including: an RIP unit (RIP processor) configured to perform RIP on data to be printed; a print instruction unit (print instructor) configured to instruct an image forming device to print RIP data; a delay detection unit (delay detector) configured to detect a page for which the RIP is delayed during on-the-fly printing that starts printing without waiting for completion of the RIP of a print job; and an alternative processing instruction unit (alternative processing instructor) configured to cause the image forming device to interrupt printing of the page and to execute an alternative processing.

### BRIEF DESCRIPTION OF DRAWINGS

Hereinbelow, embodiments of the present invention is described in detail with reference to the drawings. The advantages and features provided by one or more embodiments of the present invention become more fully understood from the detailed description given hereinbelow and the appended drawings, which are given by way of illustration only and thus are not intended as a definition of the limitations of the present invention.

FIG. 1 is a schematic diagram illustrating a whole configuration of an image forming system according to an embodiment of the present invention.

FIG. 2 is a block diagram illustrating a configuration of the image forming device.

FIG. 3 is a block diagram showing a configuration of a controller.

FIG. 4 is an image diagram showing holding and transmission of RIP data by the controller, reception and holding of the RIP data by the image forming device, and printing and output of printed material by the image forming unit.

FIG. 5 is a flowchart showing a processing at a time when the RIP is delayed.

FIG. 6 is an explanatory diagram showing an example of a case in which a nozzle deficiency detection is executed as an alternative process.

FIG. 7 is an explanatory diagram showing another example of a case in which nozzle deficiency detection is executed as an alternative processing.

FIG. 8 is an explanatory diagram showing an example of a case in which a sample printing is executed as an alternative processing.

FIG. 9 is an explanatory diagram showing an example of a case in which a color difference monitoring is executed as an alternative process;

FIG. 10 is a flowchart showing a processing at a time of double-sided printing.

FIG. 11 is an explanatory diagram showing an example of a case in which the RIP delay occurs at the sixth page (back surface).

FIG. 12 is an explanatory diagram illustrating an example of a screen of an operation display for designating which alternative processing is to be executed and in which order the alternative processing is to be executed when the RIP delay occurs.

FIG. 13 is a flowchart showing an example of executing the alternative processing designated in FIG. 12.

### DESCRIPTION OF EMBODIMENTS

Hereinbelow, embodiments of the present invention are described in detail with reference to the drawings as appropriate. However, the scope of the present invention is not limited to the disclosed embodiments.

Note that the same reference signs as those in respective figures denote the common members between the figures.

### Image Forming System

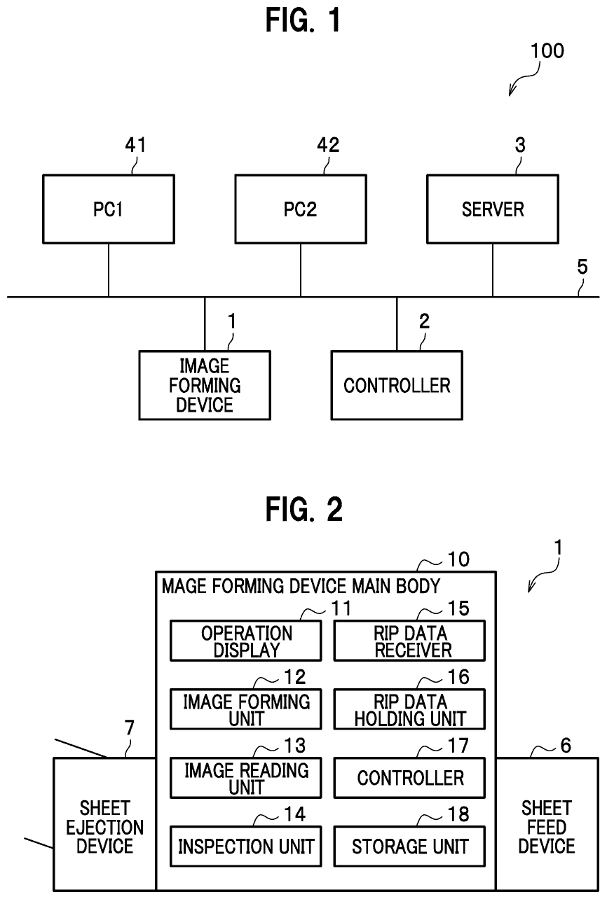

FIG. 1 is a schematic diagram illustrating a whole configuration of an image forming system 100 according to an embodiment of the present invention.

As illustrated in FIG. 1, the image forming system 100 is a system including an image forming device 1 that forms an image in a storage medium.
The image forming system 100 executes an on-the-fly printing that starts printing without waiting for the RIP of all pages included in a print job.
The client operates the print terminals 41 and 42 and a server 3 to transmit document data from the print terminals 41 and 42 and the server 3 to a controller 2, and the controller 2 instructs the image forming device 1 to perform printing, whereby the document data is printed on a recording medium.
The image forming system 100 includes the image forming device 1, the controller 2, the server 3, the print terminal 41, and the print terminal 42, which are connected to each other via a network 5.

The storage medium used in the image forming system 100 is a medium capable of recording and storing.

Any recording medium may be used as long as an image can be formed on a surface of the recording medium.
The recording medium is, for example, a sheet, a textile, a plastic film, a glass plate, and the like.
Hereinafter, a description is given of a case in which a sheet is used as a recording medium.

The print terminals 41 and 42 each may be used to transmit a print request to a multi-function peripheral (MFP, not illustrated).

The print request includes printing information including a page description language (PDL) data and control information indicating specific execution conditions of printing.
The print terminals 41 and 42 generate print data described in the PDL based on the document data and transmit the generated data to the controller 2.
Each of the print terminals 41 and 42 includes an input device such as a keyboard or a mouse, and a display.

The network 5 is used to connect the print terminals 41 and 42 to the multifunction function peripheral such that they can communicate with each other.

The network 5 includes various networks such as a combination of a local area network (LAN: Local Area Network) that connects computers and network devices in accordance with a standard such as Ethernet (R), token-ring, or Fiber-Distributed Data Interface (FDDI), a wide area information communication network (Wide Area Network (WAN)) that connects between LANs through a dedicated line; and the Internet, and the like.
The network protocol is, for example, the Transmission Control Protocol/Internet Protocol (TCP/IP).
The types and the number of devices connected to the network 5 are not limited to two as illustrated in FIG. 1 and may be changed as appropriate.

### Image Forming Device

FIG. 2 is a block diagram illustrating a configuration of the image forming device 1. As shown in FIG. 1 and FIG. 2, the image forming device 1 is an apparatus that receives print data transmitted from the print terminals 41 and 42 and forms an image corresponding to the print data on a sheet.

The image forming device 1 is assumed to be an image forming device of an inkjet type as an example, but is not limited thereto, and may be another type of apparatus such as an electrophotographic type that forms a toner image, for example.

As shown in FIG. 2, the image forming device 1 includes an image forming device main body 10, a sheet feed device 6, and a sheet ejection device 7.

The image forming device 1 has a function of reading and inspecting a specific chart using the image reading unit 13.

In addition, when the image forming device 1 illustrated in FIG. 2 is a toner machine, it is necessary to periodically execute the image stabilization.

Therefore, when the image forming device 1 has an image stabilization function, the alternative processing instruction unit 28 preferably causes the image stabilization to be executed as the alternative processing.

The image forming device main body 10 includes an operation display 11, an image forming unit 12, an image reading unit 13, an inspection unit 14, RIP data receiver 15, RIP data holding unit 16, a controller 17, and a storage unit 18.

The operation display 11 includes, for example, a touch screen display in which a touch screen is laminated on an upper side of a liquid crystal display.

The operation display 11 includes a touch screen for inputting settings of a job to be executed using the image forming system 100, and a liquid crystal display for displaying content of an operation on the touch screen.
The operation display 11 is disposed at an upper surface of the image forming device 1. Note that the operation display 11 may display image formed by the image forming system 100 and other images.

The operation display 11 is used for input of printing condition and various settings such as execution timing of adjustment of forming positions of front and back images, display of an apparatus state, input of various instructions, and the like.

Further, a user can operate the operation display 11 to input and display sheet information for sheets stored in respective sheet feed trays.
The sheet information includes a type of sheet (plain paper, high-quality paper, color paper, coated paper, overprint sheet (printed sheet), or the like), basis weight, thickness, size, and the like of the sheet.
The input sheet information is stored in the storage unit 18 in association with each sheet feed tray or the sheet feed device 6.

The image forming unit 12 is a device that prints RIP data received from the controller 2 on a sheet supplied from a sheet feed tray of the sheet feed device 6.

The RIP data is image data generated in a raster format.
The image forming unit 12 is provided with inkjet heads of four colors of, for example, yellow (Y), magenta (M), cyan (C), and black (K).
Note that the image forming unit 12 includes four inkjet heads for four colors, but is not limited to the four types of inkjet head and may be appropriately changed.
As the ink, for example, UV ink is used.

The UV light source is a light source for curing the UV ink attached to the sheet in the image forming unit 12 by irradiating a conveyed sheet with ultraviolet light.

The UV light source includes, for example, a UVLED.

The image reading unit 13 is a device that reads image on the front and back of the sheet on a conveyance path.

The image reading unit 13 has a function of reading a specific chart.
The image reading unit 13 includes a reading unit (not illustrated) that reads image printed on a conveyed sheet, a conveyance path, and a spectrocolorimeter that spectroscopically measures color of each color patch in a color evaluation image on the sheet and measures a spectral reflectance of each wavelength in a visible light region and its vicinity region.

The inspection unit 14 is an image inspection part that performs inspection by comparing an inspection target image with an image read by the image reading unit 13. When the inspection unit 14 detects a defect in an image read by the image reading unit 13 and then detects a defect again on the same place in an image that the image reading unit 13 reads from a sheet subjected to recovery reprinting by the image forming unit 12, the inspection unit 14 performs image correction of the defect on the same place in the image data for recovery re-reprinting on which the image forming unit 12 performs image formation.

The RIP data receiver 15 is a device that receives and stores RIP data output from the print instruction unit 23 of the controller 2.

The RIP data receiver 15 outputs the received RIP data in units of pixel array (line) in order from a downstream in a sheet conveying direction among a plurality of pixel arrays each formed with a plurality of pixels arranged in a main scanning direction.
The RIP data holding unit 16 is a transmitting means for transmitting RIP data to the image forming device 1.

The controller 17 includes a computer (not shown) that controls the image forming system 100 and the entire operation of the image forming system 100.

The controller 17, based on an operation of the operation display 11 and a reception signal from the image forming system 100 connected to the image forming device 1, controls each unit of the image forming device 1 and an operation of each part of the sheet feed device 6 and a post-processing device 4.
Further, the controller 17 adjusts color of an image and an image forming position based on the image data obtained by the image reading unit 13.
For example, the forming position of the image is adjusted by reading an edge of a sheet, a register mark, a dedicated chart, and the like to use them to adjust the forming position of the image.

The computer includes a central processing unit (CPU), a read only memory (ROM), a random access memory (RAM), an input/output circuit, and the like.

The CPU reads a program according to processing contents from the storage unit 18, develops the program in the RAM, and cooperates with the developed program to control each component of the image forming system 100.
At this time, various kinds of data stored in a storage unit 18 are referred to.
The program is a so-called firmware program that causes the computer to execute various sequences to process information.

The storage unit 18 is a storage device that stores information regarding the image forming system 100, information regarding a state of each sheet feed tray (not illustrated) of the sheet feed device 6 that accommodates sheets, and the like.

The storage unit 18 stores image data such as a color chart in which color patches having a plurality of colors for various kinds of evaluation are arranged and a front/back position adjustment chart dedicated for adjusting front/back image positions.
The storage unit 18 includes, for example, a nonvolatile semiconductor memory (so-called flash memory) and a hard disk drive.

### Sheet Feed Device

As illustrated in FIG. 2, the sheet feed device 6 includes a sheet feed tray (not illustrated) having a plurality of trays for feeding a sheet.

The sheet feed tray includes, for example, a plurality of trays such as an upper tray, a middle tray, and a lower tray that each stores sheets.
Each tray has a lid in its housing, and the lid is opened to perform replenishment, replacement, and the like of the sheet.
The sheet in the sheet feed device 6 is conveyed through a fed sheet conveying unit (not illustrated) to the image forming unit 12.
The sheet on which image formation is performed by the image forming unit 12 is passed through the conveyance path, subjected to each processing according to the print setting of the print job, and then placed on a sheet ejection tray of the sheet ejection device 7.

### Sheet Ejection Device

The sheet ejection device 7 is a device that ejects a sheet on which image formation has been performed by curing dots through irradiation with ultraviolet rays from a UV light source to the outside of the image forming device body 10.

The sheet ejection device 7 is positioned at a rear end of the sheet conveyance path, and includes a sheet ejection roller, a sheet ejection tray, and the like.

### Controller

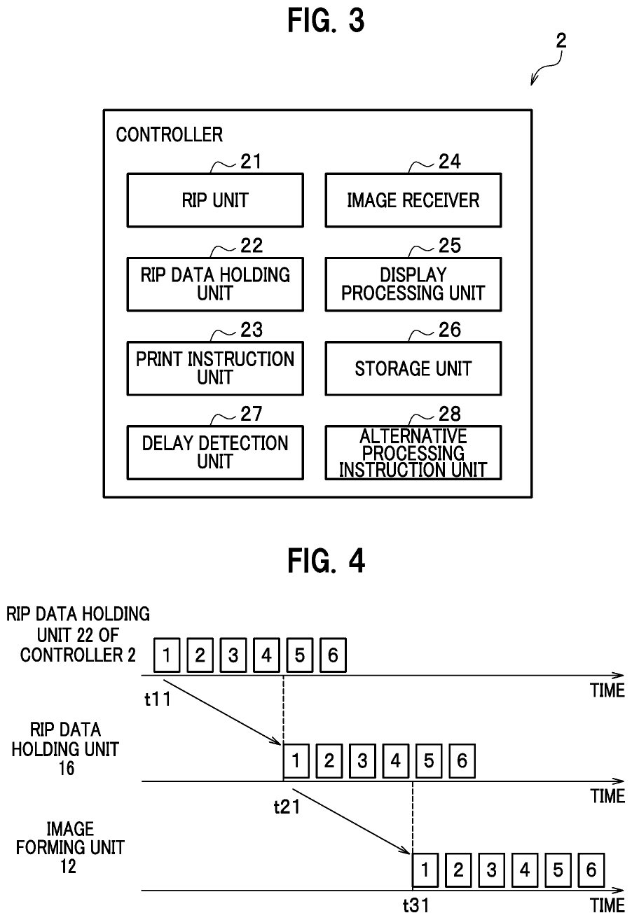

FIG. 3 is a block diagram showing a configuration of the controller 2.

As shown in FIG. 3, the controller 2, when receiving document data, performs RIP for converting the document data into image data in a raster format and converting the image data into an image, and transmits the RIP data to the image forming device 1.
The controller 2, when detecting a page whose RIP is delayed, causes the image forming device 1 to interrupt printing of the page and to execute an alternative processing.
The controller 2 includes RIP unit 21, RIP data holding unit 22, a print instruction unit 23, an image receiving unit 24, a display processing unit 25, a storage unit 26, a delay detection unit 27, and an alternative processing instruction unit 28.

The RIP unit 21 performs RIP of converting image information described in the page description language into a raster image to generate RIP data.

When an image is formed by the image forming device 1, the RIP unit 21 converts image data input from the print terminals 41 and 42 or the like into image data for printing.
The image data on which the RIP has been performed is transmitted to the image forming unit 12 as the image data for printing, and on the basis of the image data after the RIP, image formation is performed by the image forming unit 12.
Note that the image data may be image data read by a scanner (not illustrated) or image data in the raster image acquired from outside.

The RIP data holding unit 22 is a retaining means for retaining the RIP data.

The print instruction unit 23 is an instruction means for transmitting the RIP data subjected to the RIP to the image forming device 1 and instructing the apparatus 1 to print the RIP data.

The image receiving unit 24 is a receiving means for receiving the RIP data transferred from the image forming device 1.

The display processing unit 25 is a display means for displaying a processing result in the RIP unit 21.
The display processing unit 25 performs processing for generating an image to be displayed on a display panel.
The storage unit 26 is a storage means for storing RIP data generated by the image forming device 1.

The delay detection unit 27 is a detection means for detecting a page for which the RIP is delayed during on-the-fly printing in which printing is started without waiting for completion of the RIP of a print job.

The alternative processing instruction unit 28 is an instruction means for instructing the image forming device 1 to interrupt the printing of the page and perform an alternative processing.

### Action of Image Forming Device

FIG. 4 is a time chart showing holding and transmission of RIP data in the controller 2, reception and holding of the RIP data in the image forming device 1, and printing and outputting of a printed material in the image forming unit 12.

In the example illustrated in FIG. 4, the RIP data holding unit 22 of the controller 2 accumulates therein the RIP data since a time t11.
At a time t21, when the RIP data holding unit 22 of the controller 2 holds four pages of RIP data, the print instruction unit 23 sequentially transmits the RIP data to the image forming device 1.
In the image forming device 1, when the RIP data for four pages is held in the RIP data holding unit 16 at the time t31, the image forming unit 12 starts the printing.
Because the printing is executed at a constant cycle (in the case of the 50 PPM machine, a cycle of 1.2 seconds), when the RIP data transmission is delayed from this processing timing, the image forming device 1 stops the printing and waits for the RIP data transmission.

In this way, the alternative processing instruction unit 28 causes the image forming device 1 to continue the RIP of the page on which the RIP is delayed and the subsequent pages and then to starts the printing, and thus it is possible to efficiently perform the printing.

### Processing Upon RIP Delay

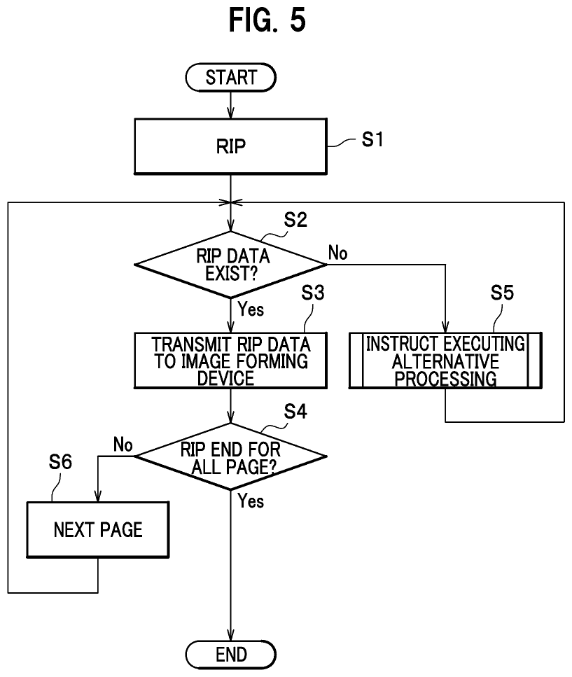

FIG. 5 is a flowchart illustrating processing at the time of RIP delay.

The processing at the time of RIP delay shown in FIG. 5 is executed by the controller 2 shown in FIG. 1 and FIG. 3.
First, the controller 2 causes the RIP unit 21 to execute RIP (step S1).

Next, the controller 2 transfers the RIP data held in the RIP data holding unit 22 to the image receiving unit 24 in order starting from the first page as appropriate.

At this time, the controller 2 checks whether there is RIP data within a specific time (step S2).

If it takes time to create the RIP data and there is no RIP data in the RIP data holding unit 22 (No in step S2), the controller 2 instructs the image forming device 1 to cause the image forming device to execute the alternative processing (step S5), and the process returns to step S2.

That is, the alternative processing instruction unit 28 causes the image forming device 1 to add an alternative processing each time the designated time of the RIP is exceeded.
Subsequently, when the RIP data exists in the RIP data holding unit 22 (Yes in step S2), the RIP data is transmitted from the print instruction unit 23 to the image forming device (step S3).

Next, the controller 2 checks whether the RIP is completed for all the page of the RIP data held in the RIP data holding unit 22 (step S4).

When the RIP is completed for all the page of the RIP data (Yes in step S4), the processing is terminated (end).
If the RIP is not completed for all the page (No in step S4), the RIP is performed for the next page (step S6), and the process returns to step S2.

When the RIP of the page for which the RIP is delayed is completed, the alternative processing instruction unit 28 illustrated in FIG. 3 can cause the image forming device 1 to resume the printing of the page as soon as the alternative processing in execution is terminated.

As shown in FIG. 5, the controller 2 creates RIP data by completing RIP of pages for each of regular intervals so as to match a production speed of the image forming device 1, and transfers the RIP data the image forming device 1.

In a case in which the controller 2 determines that a certain page will not make it on its print timing (a scheduled RIP completion time of the page) when the delay of the RIP occurs on this page, the controller 2 instructs the image forming device 1 to execute the alternative processing without transferring the image data thereto.
Upon receiving the instruction for the alternative processing, the image forming device 1 executes the alternative processing without printing the page.

As described above, in the image forming system 100 according to the present invention, in a case in which it takes time to create the RIP data and there is no RIP data in the RIP data holding unit 22, the RIP of the RIP data for all pages is performed by, for example, executing the alternative processing.

Thus, the image forming system 100 can effectively utilize the RIP waiting time until the RIP is completed.

### Execution Example of Nozzle Deficiency Detection as Alternative Processing

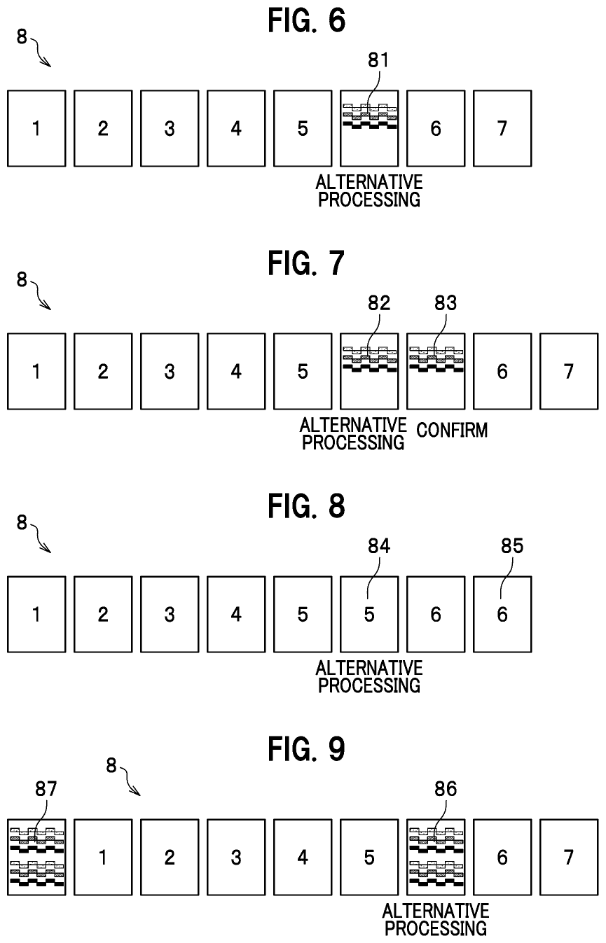

FIG. 6 is an explanatory diagram illustrating an example of a case in which the nozzle deficiency detection is executed as the alternative processing.

In the example illustrated in FIG. 6, the delay of the RIP occurs at the sixth page.
In this case, the insertion-printing of the nozzle deficiency detection chart 81 is performed as the alternative processing.
In the image forming device 1 illustrated in FIG. 2, the image reading unit 13 reads an image of a printed material, and the inspection unit 14 checks whether or not there occurs a nozzle deficiency in which ink droplet is not ejected.
As illustrated in FIG. 6, the RIP data of the sixth page can be generated after a delay of one page, and thus the sixth page is printed by the image forming device 1 after the alternative processing.

That is, the alternative processing instruction unit 28 instructs the image forming device 1 to perform the nozzle deficiency detection as the alternative processing.

The image forming device 1 executes the nozzle deficiency detection by printing the nozzle deficiency detection chart.

The image data for the alternative processing is stored in the storage unit 26 of the controller 2, and is transmitted to the image forming device 1 together with an instruction command (see FIG. 1 or 3).

Alternatively, the image data for the alternative processing may be stored in the storage unit 18 of the image forming device 1, and only the instruction command may be transmitted from the controller 2 (see FIG. 1 or 3).

As described above, in a case in which the nozzle deficiency detection is executed as the alternative process, even when the delay of the RIP occurs, the nozzle deficiency can be detected by printing the nozzle deficiency detection chart as the alternative process, this allows effective utilization of the RIP waiting time.

### Another Example of Nozzle Deficiency Detection as Alternative Processing

FIG. 7 is an explanatory diagram showing another example of a case in which nozzle deficiency detection is executed as the alternative processing.

The example illustrated in FIG. 7 is an example of a case in which the nozzle deficiency detection is executed as the alternative process similarly to FIG. 6, and is a case in which the nozzle deficiency is detected by the inspection unit 14 (refer to FIG. 2) of the image forming device 1.
In the image forming device 1, the correction processing of the nozzle ejection is executed, and the nozzle deficiency detection charts 82 and 83 are printed for confirmation of the correction result.
Printing of the nozzle deficiency detection charts 82 and 83 is automatically performed by the image forming device 1.
In this manner, in a case in which the nozzle deficiency detection is executed as the alternative processing, the correction of the nozzle ejection and the confirmation of the nozzle ejection are added.

That is, the alternative processing instruction unit 28 shown in FIG. 3 can cause the image forming device 1 to continuously execute the alternative processing including the process of monitoring maintenance of the image quality and correcting it, and the printing. The alternative processing is the process for monitoring the maintenance of the image quality and correcting it, and this alternative processing does not interrupt the printing of the image forming device 1.

Furthermore, the alternative processing instruction unit 28 can instruct the image forming device 1 to perform insertion-printing of the nozzle deficiency detection chart as the alternative processing, and when the nozzle deficiency is detected, to reprint the nozzle deficiency chart for confirmation after the correction processing is performed.

In this way, as shown in FIG. 7 or FIG. 2, the image forming device 1 executes the correction process of the nozzle ejection when the inspection unit detects the nozzle deficiency 14, and automatically prints the nozzle deficiency detection charts 82 and 83 for the confirmation. Therefore, when a nozzle deficiency occurs, the image forming device 1 can automatically perform the nozzle ejection correction and notify the user that a nozzle deficiency has occurred and thereby enabling efficient printing.

### Execution Example of Sample Printing as Alternative Processing

FIG. 8 is an explanatory diagram illustrating an example of a case in which sample printing is executed as the alternative processing.

In the example illustrated in FIG. 8, a delay in the RIP has occurred on the sixth page, and insertion-print is executed for the same RIP data 84 and 85 as those for the previous page as alternative processing.
The printed material 8 on which the same RIP data 84 and 85 as those for the previous page is printed is ejected to a sheet ejection tray (not illustrated) different from that for the main text.

That is, the alternative processing instruction unit 28 (see FIG. 3) can cause the image forming device 1 to insert, as the alternative processing, the sample printing in which the same page as the printed previous page is reprinted and ejected to another tray.

The above operation allows the RIP waiting time to be utilized as the time for sample printing.

Therefore, even during printing, the user can visually confirm that the same RIP data 84 and 85 as the previous page is being printed.

### Execution Example of Color Difference Monitoring as Alternative Processing

FIG. 9 is an explanatory diagram illustrating an example of a case in which the color difference monitoring is executed as the alternative processing.

In the example illustrated in FIG. 9, a delay in the RIP has occurred on the sixth page, and insertion-printing of the color difference monitoring chart 86 is executed as the alternative processing.
When the color difference of read image of the printed material 8 is inspected, the color difference monitoring prints and reads the color difference monitoring chart 87 before printing of a job, next, prints and reads the color difference monitoring chart 86, and compares their two reading results to extract the color difference between them.
Therefore, this alternative processing can be executed only for a job for which the color difference monitoring is directed.

It is possible to instruct, before printing, that the nozzle deficiency detection, the sample printing, and the color difference monitoring are periodically inserted.

For example, when the insertion is performed at an interval of 10 pages, the insertion is performed at the following points indicated by “*”.

### Pages: 1, 2, 3, 4, 5, 6, 7, 8, 9, 10, *, 11, 12, 13, 14, 15, 16, 17, 18, 19, 20, *, 21, 22, and 23 - - -

In this job, as shown in FIG. 6, FIG. 8 and FIG. 9, when the RIP of the sixth page is delayed and the alternative processing is executed after the fifth page, the scheduled next insertion after the 10th page can be canceled as follows.

### Pages: 1, 2, 3, 4, 5, *, 6, 7, 8, 9, 10, 11, 12, 13, 14, 15, 16, 17, 18, 19, 20, *, 21, 22, and 23.

Alternatively, it is possible to newly schedule the insertion at intervals of 10 pages after the alternative processing as follows.

### Pages: 1, 2, 3, 4, 5, *, 6, 7, 8, 9, 10, 11, 12, 13, 14, 15, *, 16, 17, 18, 19, 20, 21, 22, and 23.

Thus, although a delay of one page occurs in the RIP, the printing (sheet feed and conveyance processing) does not stop, and there is no difference in the print completion time for all the pages.

As described above, in a case in which the nozzle deficiency detection chart is printed as the alternative processing in a job in which the nozzle deficiency detection chart is scheduled to be inserted for each specified number of sheets, the alternative processing instruction unit 28 can cause the image forming device 1 to cancel the page insertion scheduled immediately after the alternative processing.

This allows the RIP waiting time to be utilized as the printing time of the nozzle deficiency detection chart, and to prevent the nozzle deficiency detection chart from being excessively printed.

In addition, in a case in which the nozzle deficiency detection chart is printed as the alternative processing in a job in which the nozzle deficiency detection chart is scheduled to be inserted for each specified number of sheets, the alternative processing instruction unit 28 can cause the image forming device 1 to reset a count of the insertion pages and change the schedule so that the nozzle deficiency detection chart is inserted for each designated number of sheets after the alternative processing.

In addition, in a case in which the sample printing is inserted as the alternative processing in the job in which the sample printing is inserted for each designated number of sheets, the alternative processing instruction unit 28 can cause the image forming device 1 to cancel the scheduled insertion page immediately after the alternative processing.

Furthermore, in a case in which the sample printing is inserted as the alternative processing in the job in which the sample printing is inserted for each designated number of sheets, the alternative processing instruction unit 28 can cause the image forming device 1 to reset the count of insertion pages and change the schedule so that the scheduled sample printing is inserted every specified number of sheets after the alternative processing.

When the color difference monitoring is set in the job, the alternative processing instruction unit 28 can cause the image forming device 1 to insert the color difference monitoring chart as the alternative processing.

In addition, the alternative processing instruction unit 28 can cause the image forming device 1 to perform insertion printing of a color difference monitoring chart as an alternative process, and to perform a correction process in a case in which the color difference is larger than a designated value when comparing it with the color difference monitoring chart printed before start of printing.

In addition, in a case in which the color difference monitoring chart is inserted as the alternative processing in the job in which the color difference monitoring chart is scheduled to be inserted for each designated number of sheets, the alternative processing instruction unit 28 can cause the image forming device 1 to cancel the insertion page scheduled immediately after the alternative processing.

In addition, in a case in which the color difference monitoring chart is inserted as the alternative processing in the job in which the color difference monitoring chart is scheduled to be inserted for each designated number of sheets, the alternative processing instruction unit 28 can cause the image forming device 1 to reset the count of the insertion pages.

Then, the alternative processing instruction unit 28 can cause the image forming device 1 to change the schedule so that the color difference monitoring chart is inserted every specified number of sheets after the alternative processing.
Furthermore, when causing the image forming device 1 to perform the alternative processing for maintaining image quality, the alternative processing instruction unit 28 can cause the image forming device 1 to interrupt printing.

### Processing Flow on Double-Sided Printing

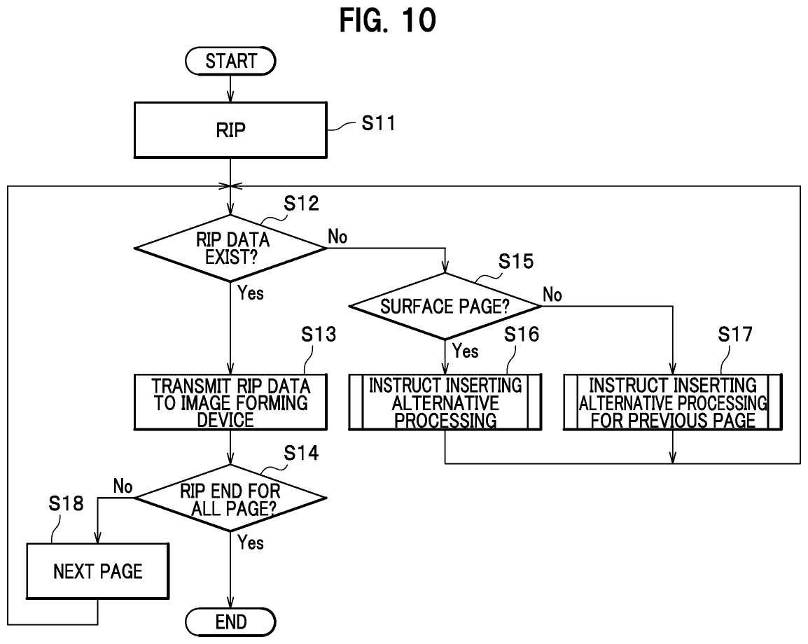

FIG. 10 is a flowchart illustrating a process for double-sided printing.

The process for double-sided printing shown in FIG. 10 is executed by the controller shown in FIG. 3.
First, the controller 2 causes the RIP unit 21 to execute RIP (step S11).

Next, the controller 2 transfers the RIP data held in the RIP data holding unit 22 to the image receiving unit 24 in order starting from the first page as needed.

At this time, the controller 2 checks whether there is RIP data within a specific time (step S12).

In step S12, if it takes a long time to create RIP data so that there is no RIP data in the RIP data holding unit 22 (No in step S12), it is confirmed whether the page is a surface page (step S15).

If the page is the surface page (Yes in step S15), the image forming device 1 is instructed to perform insertion so that the image forming device executes alternative processing (step S16), and the process returns to step S2.
If the page is not the surface page (No in step S15), the image forming device 1 is instructed to perform insertion so that the image forming device executes alternative processing one page before (step S16), and the process returns to step S12.

That is, when detecting that the RIP on the back surface page is not in time in the double-sided printing, the alternative processing instruction unit 28 can cause the image forming device 1 to perform alternative processing before start of printing on the surface.

In step S12, when the RIP data is present in the RIP data holding unit 22 (Yes in step S12), the RIP data is transmitted from the print instruction unit 23 to the image forming device (step S13).

Next, the controller 2 confirms whether the RIP of all the pages of the RIP data held in the RIP data holding unit 22 is completed (step S14).

If the RIP is not completed for all the pages (No in step S14), the RIP for the next page is performed (step S18), and the process returns to step S12.

When the RIP is completed for all the pages of the RIP data (Yes in step S14), the processing is terminated (end).

As described above, the image forming system 100 according to the present invention executes the alternative processing one page before when the delay of the RIP occurs in the back surface page.

The time from the completion of the RIP by the controller 2 to the transfer of image data or the time from reception of the image data to the printing by the image forming device 1 is a margin of several pages (for example, four pages).
Therefore, it is possible to issue an instruction to perform the alternative processing one page before.
Because the alternate processing is executed by-sheet basis, the image forming device 1 automatically performs processing for two page (front and back sides).

### Processing Example on RIP Delay for Back Surface

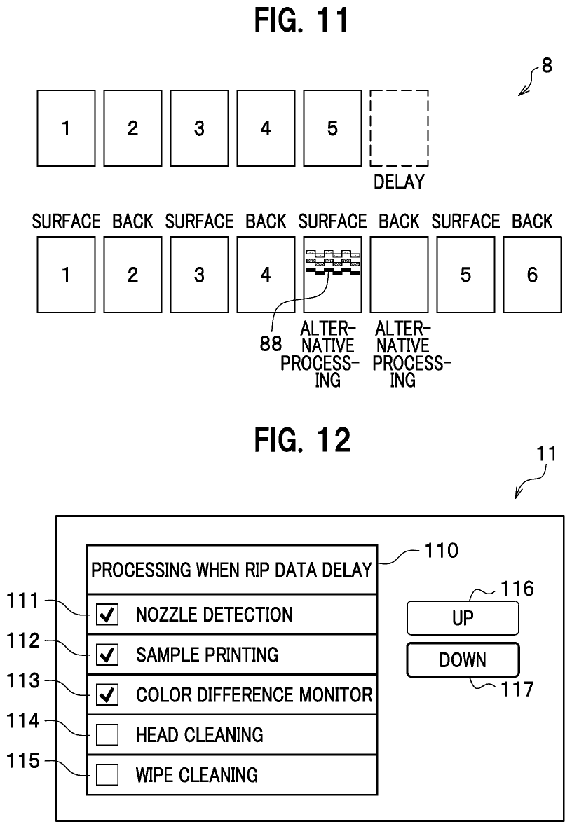

FIG. 11 is an explanatory diagram illustrating an example of a case in which a delay of the RIP occurs in the sixth page (back surface).

In the example illustrated in FIG. 11, the delay of the RIP occurs on the sixth page (back surface).
In the present case, insertion-printing of the nozzle deficiency detection chart 88 is executed for the surface as the alternative processing.
In the image forming device 1 illustrated in FIG. 2, the image reading unit 13 reads an image of a printed material and the inspection unit 14 inspects presence or absence of a nozzle deficiency in which ink droplet is not ejected.
As shown in FIG. 11, because the RIP data of the fifth page which is a previous page can be created, the alternative processing is performed and then the fifth and sixth pages are printed by the image forming device 1.
The image data for the alternative processing is stored in the storage unit 26 of the controller 2 and transmitted to the image forming device 1 together with an instruction command (see FIG. 1 or 3).

As described above, in a case in which the nozzle deficiency detection is executed as the alternative processing, even if the delay of the RIP occurs, the front or back surfaces of the previous page to a page in which the delay of the RIP occurs can be printed by the image forming device 1.

Therefore, printing can be performed efficiently and quickly.

### Execution Example of Alternative Processing on RIP Delay

FIG. 12 is an explanatory diagram illustrating an example of a screen 110 of the operation display 11 for designating which alternative processing is to be executed and in which order the alternative processing is to be executed when a delay of the RIP occurs. When a delay occurs in the RIP, the user can select an alternative processing to be executed and designate the order of execution by operating the screen 110 of the operation display 11 shown in FIG. 12.

At this time, it is also possible for the user to execute none of alternative processing.

In that case, as in the normal operation, the image forming device 1 suspends the printing until the RIP is completed and the print data is transferred.

The screen 110 of the operation display 11 includes, for example, nozzle detection 111, sample printing 112, color difference monitoring 113, head cleaning 114, and wipe cleaning 115 for processing on a time of the RIP data delay.

In addition, the screen 110 includes an upward operation part 116 and a downward operation part 117 for moving a cursor when selecting one of the above operation for the RIP data delay.

In addition, it is preferable that the image forming device 1 shown in FIG. 2 has the operation display 11 provided with a selection switch capable of preventing the nozzle deficiency detection chart insertion page from being changed.

Furthermore, the image forming device 1 preferably includes the operation display 11 that can prevent the sample print insertion page from being changed.
Furthermore, the image forming device 1 preferably includes the operation display 11 that allows the user not to change the color difference monitoring chart page.
In addition, the image forming device 1 preferably includes the operation display 11 capable of designating in advance which alternative processing is to be executed.

### Flow for Executing Alternative Processing Selected on Screen of Operation Display

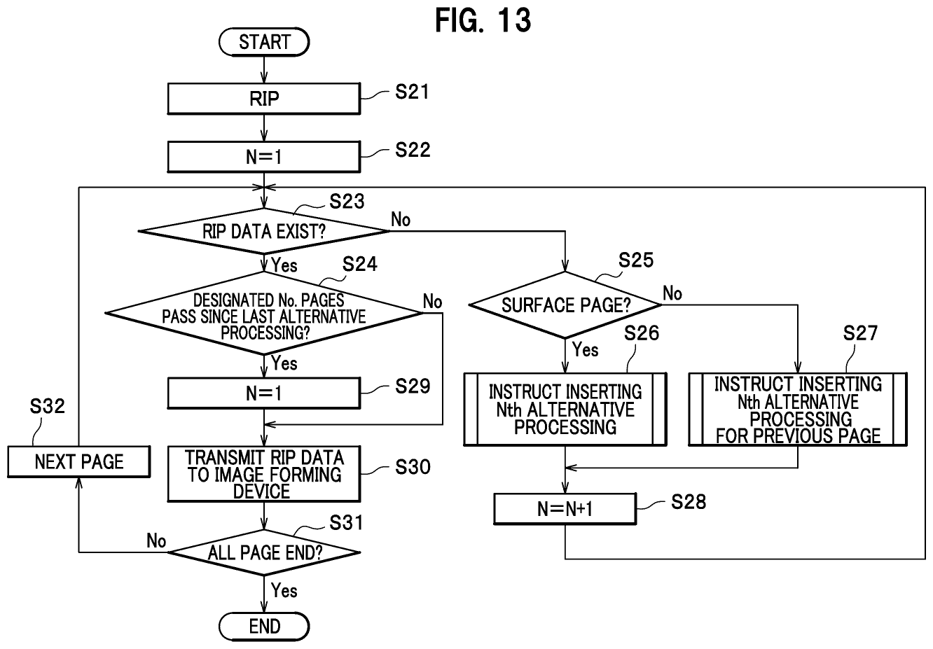

FIG. 13 is a flowchart illustrating an example of executing the alternative processing specified in FIG. 12.

When the alternative processing selected on the screen 110 of the operation display 11 illustrated in FIG. 12 is executed, the alternative processing selected is executed by the controller 2 illustrated in FIG. 3.
The controller 2 executes the alternative processing in the designated order.
First, the controller 2 causes the RIP unit 21 to execute the RIP (step S21).

Next, the controller 2 causes the first (N=1) alternative processing to be executed (step S22).

At this time, the controller 2 checks whether there is the RIP data within a specific time (step S23).

In step S23, if there is the RIP data in the RIP data holding unit 22 (Yes in step S23), the controller 2 confirms whether the page is a surface page (step S25).

If the page is the surface page (Yes in step S25), the controller 2 instructs the image forming device 1 to perform insertion so that the image forming device executes the Nth alternative processing (step S26).
Subsequently, the controller 2 transfers the RIP data for one page (N=1) held in the RIP data holding unit 22 to the image receiving unit 24 (step S28), and the process returns to step S23.

If the page is not the surface page in step S25 (No in step S25), the controller 2 instructs the image forming device 1 to perform insertion so that the image forming device executes the Nth alternative processing for the previous page (step S27).

The controller 2 executes the second (N=N+1) alternative processing (step S28), and the process returns to step S23.

If there is the RIP data in the RIP data holding unit 22 (yes in step S23), the controller 2 confirms whether a designated number of pages passes since the last alternative processing (step S24).

If the designated number of pages (for example, 100 pages) passes since the execution of the previous alternative process (Yes in step S24), the first (N=1) alternative processing is executed (step S29).
Note that when the number of printed sheets is smaller than that in the previously performed alternative processing, the alternative processing instruction unit 28 can also cause the image forming device 1 to change the alternative processing to another processing.
Next, the print instruction unit 23 sends the RIP data to the image forming device (step S30).

In step S24, if the designated number of pages are not passed since the last alternative processing (No in step S24), the process proceeds to step S30 and the print instruction unit 23 sends the RIP data to the image forming device.

Next, the controller 2 confirms whether the RIP for all the pages of the RIP data held in the RIP data holding unit 22 is completed (step S31).

If the RIP is not completed for all the pages (No in step S31), the RIP for the next page is performed (step S32), and the process returns to step S23.
If the RIP is completed for all the pages (YES in step S31), the process is terminated (END).

In a case in which the delay of the RIP occurs in the same page and all of the selected alternative processing is finished, it is preferable that the image forming device 1 interrupts the printing until the RIP is completed and the print data is transferred as in the normal operation.

When the RIP delay occurs more than the designated number of times, the alternative processing instruction unit 28 illustrated in FIG. 3 preferably instructs the image forming device 1 to perform the alternative processing that takes more processing time than that of the alternative processing instructed so far.

In addition, in FIG. 13, in a case in which the alternative processing is repeated for the same page and the alternative processing of stopping print processing such as head cleaning, wipe cleaning, or image stabilization is performed, the alternative processing may be executed after stopping the alternative processing instructed before.

The time from the completion of the RIP by the controller 2 to the transfer of image data or the time from reception of the image data to the printing by the image forming device 1 is a margin of several pages (for example, four pages).

For this reason, the controller 2 can issue an instruction to interrupt printing before a page for which printing of the alternative processing is not started and to execute the alternative processing of the head cleaning, the wipe cleaning, and the image stabilization.

### Effects of Embodiments

The image forming system, the alternative processing execution method, and the alternative processing execution program of the present invention can effectively utilize an RIP waiting time until the RIP for a specific page is completed and printing the page is resumed in the on-the-fly printing.

As described above, the image forming system 100 of the present invention illustrated in FIG. 1 or FIG. 3 includes the RIP unit 21 that performs RIP on print data, the print instruction unit 23 that instructs the image forming device 1 to print the RIP data, the delay detection unit 27 that detects a page on which RIP is delayed during the on-the-fly printing in which printing is started without waiting for completion of the RIP of a print job, and the alternative-processing instruction unit 28 that causes the image forming device 1 to interrupt printing for the page and perform alternative processing.

According to such a configuration, in the image forming system 100, when the delay detection unit 27 detects a page for which the RIP is delayed, the alternative processing instruction unit 28 causes the image forming device 1 to interrupt the printing of the page and to execute the alternative processing.

Therefore, when a delay occurs in the RIP, the image forming system 100 executes image quality state confirmation processing, image quality correction processing, and maintenance processing instead of printing, and thereby allowing effective utilization of the waiting time for the RIP.
Thus, the present invention, when the RIP for a specific page is delayed and printing is interrupted during the on-the-fly printing, allows utilizing a waiting time until the RIP is completed to resume printing.

Furthermore, as illustrated in FIG. 3 to FIG. 5, the alternative processing instruction unit 28 continues the RIP on the page on which the RIP is delayed and the subsequent pages during the execution of the alternative processing.

According to such a configuration, the alternative processing instruction unit 28 continues the RIP on the page on which the RIP is delayed and the subsequent pages, which allows shortening of the time until the RIP is completed.

Further, as shown in FIG. 1, FIG. 3, or FIG. 5, the alternative processing instruction unit 28, when the RIP of the page for which the RIP is delayed is completed, causes the image forming device 1 to resume the printing of the page as soon as the alternative processing being executed is terminated.

According to such a configuration, when there occurs a page for which the RIP is delayed during the on-the-fly printing, processing for monitoring image quality maintenance is executed as the alternative processing for the page.

When the RIP is finished, the alternative processing instruction unit 28 transfers the image data to the image forming device 1 at the next interval from a point at which the alternative processing is instructed and resumes the printing after the alternative processing.
Therefore, because the image forming device 1 executes the processing for monitoring image quality maintenance instead without stopping the printing, the RIP waiting time until the RIP is completed can be effectively utilized.

In addition, as illustrated in FIG. 10 and FIG. 11, when detecting that the RIP for the back surface is not in time in double-sided printing, the alternative processing instruction unit 28 (see FIG. 3) causes the image forming device 1 to execute the alternative processing before the printing on the surface is started.

According to such a configuration, when detecting that the RIP on the back surface is not in time in the double-sided printing, the alternative processing instruction unit 28 allows the alternative processing to be executed before the printing on the surface is started, thereby substantially reducing the time taken for the RIP.

Further, as shown in FIG. 6 and FIG. 7, the alternative processing is a process for monitoring the maintenance of the image quality and for correction process, and the printing by the image forming device 1 is not interrupted when the alternative processing is executed.

According to such a configuration, because the alternative processing allows continuous execution of the processing of the monitoring maintenance of image quality, the correction processing, and the printing, it is possible to make printing efficient.

In addition, as illustrated in FIG. 3 or FIG. 6, the alternative processing instruction unit 28 instructs the image forming device 1 to perform the nozzle deficiency detection as the alternative process, and the image forming device 1 prints the nozzle deficiency detection chart and performs the nozzle deficiency detection.

According to such a configuration, the alternative processing instruction unit 28 instructs the image forming device 1 to perform the nozzle deficiency detection as the alternative processing and causes the image forming device 1 to print the nozzle deficiency detection chart, and thus this makes printing efficient.

Furthermore, as illustrated in FIGS. 3, 6, or 7, the alternative-processing instruction unit 28 causes the image forming device 1 to perform insertion-printing of the nozzle deficiency detection chart as the alternative processing and to re-print a nozzle deficiency chart for confirmation after correction is performed when nozzle deficiency is detected.

According to such a configuration, in a case in which the nozzle deficiency occurs, the alternative processing instruction unit 28 causes the image forming device 1 to perform the correction of the nozzle ejection and to reprint the nozzle deficiency chart for confirmation, which allows notifying a user that the nozzle deficiency occurs.

In addition, as illustrated in FIG. 3 or 9, in a case in which the nozzle deficiency detection chart is printed as the alternative processing in a job in which the nozzle deficiency detection chart is inserted for each designated number of sheets, the alternative-process instructing unit 28 causes the image forming device 1 to cancel the page insertion scheduled immediately after the alternative processing.

According to such a configuration, in a case in which the nozzle detection chart is printed as the alternative processing, the alternative processing instruction unit 28 causes the page scheduled to be printed immediately after the alternative processing to be cancelled, and thus allows avoiding wasteful printing.

Further, as shown in FIG. 3 or FIG. 9, in a case in which the nozzle deficiency detection chart is printed as the alternative processing in the job in which the nozzle deficiency detection chart is scheduled to be inserted for each designated number of sheets, the alternative-process instructing unit 28 resets the count of the insertion pages and changes the schedule so that the nozzle deficiency detection chart is inserted for each designated number of sheets from after the alternative processing.

According to such a configuration, in a case in which the nozzle deficiency detection chart is printed, the alternative processing instruction unit 28 causes the count to be reset the count of insertion pages, and causes the schedule to be changed to perform insertion-printing of the nozzle deficiency detection chart for each specified number of pages from after the alternative processing, so that desired pages can be printed.

Further, as shown in FIG. 2 or FIG. 9, the image forming device 1 includes the operation display 11 which can be operated for preventing an insertion page of the nozzle deficiency detection chart from being changed.

According to such a configuration, the user can appropriately select not to change the insertion page of the nozzle deficiency detection chart by operating the operation display 11.

Further, as shown in FIG. 3 or FIG. 8, the alternative processing instructing unit 28 causes the image forming device 1 to insert, as the alternative processing, a sample printing in which the same page as the printed previous page is reprinted and discharged to another tray.

According to such a configuration, the alternative processing instruction unit 28 can instruct the image forming device 1 to perform sample printing as the alternative processing. Because the image forming device 1 can print the previous page again and discharge this re-printed page to another tray, the printed material of the previous page and the re-printed material of the same page can be sorted, which is convenient.

Furthermore, as illustrated in FIG. 3 or 9, when the sample printing is inserted as the alternative processing in a job in which the sample printing is inserted every designated number of sheets, the alternative processing instruction unit 28 allows the image forming device 1 to cancel the immediately subsequent scheduled insertion page.

According to such a configuration, in a case in which the sample printing is inserted as the alternative processing, the alternative processing instruction unit 28 can cause the scheduled insertion page immediately after the alternative processing to be cancelled, which allows avoiding wasteful printing.

Furthermore, as illustrated in FIG. 3 or 9, when the sample printing is inserted as the alternative processing in a job which is set so that the sample printing is inserted every specified number of sheets, the alternative processing instruction unit 28 causes the image forming device 1 to reset the count of inserted pages and change the schedule so that the sample printing is inserted every specified number of sheets from after the alternative processing.

According to such a configuration, in a case in which the sample printing is inserted as the alternative processing, the alternative processing instruction unit 28 can reset the count of the insertion pages and change the schedule so as to perform insertion every specified number of sheets from after the alternative processing, which is convenient.

Furthermore, as illustrated in FIG. 9 or 12, the image forming device 1 includes the operation display 11 which is operated to prevent the sample print insertion page from being changed.

According to such a configuration, the user can operate the operation display 11 to appropriately select not to change the sample printing insertion page.

As shown in FIG. 3 or 9, when a job is set to perform color difference monitoring, the alternative processing instruction unit 28 causes the image forming device 1 t insert the color difference monitoring chart as the alternative processing.

According to such a configuration, the alternative processing instruction unit 28 can instruct the image forming device 1 to perform the color difference inspection process as the alternative process to print the color difference inspection chart, and to execute the color difference calculation process.

Further, as shown in FIG. 3 or FIG. 9, the alternative processing instruction unit 28 causes the image forming device 1 to perform insertion-printing of the color difference monitoring chart as the alternative process, and to execute the correction process when the color difference is larger than the designated value in comparison with the color difference monitoring chart printed before the start of printing.

According to such a configuration, the alternative processing instruction unit 28 can cause the correction processing to be executed in a case in which the color difference is larger than the specified value in comparison with the color difference monitoring chart printed before the start of printing and thus can appropriately perform the correction processing according to the color difference.

Furthermore, as illustrated in FIG. 3 or 9, when a color difference monitoring chart is inserted as the alternative processing in a job in which a color difference monitoring chart is inserted every specified number of sheets, the alternative processing instruction unit 28 causes the image forming device 1 to cancel the immediately subsequent scheduled insertion page.

According to such a configuration, in a case in which the color difference monitoring chart is inserted as the alternative process, the alternative processing instruction unit 28 can appropriately cancel the printing of the immediately subsequent scheduled insertion page as necessary, which is convenient.

Furthermore, as illustrated in FIG. 3 or 9, when a color difference monitoring chart is inserted as the alternative processing in a job in which a color difference monitoring chart is inserted every specified number of sheets, the alternative processing instruction unit 28 causes the image forming device 1 to reset the count of inserted pages and to change the schedule so that the color difference monitoring chart is inserted every specified number of sheets from after the alternative processing.

Such a configuration is convenient because, in a case in which the color difference monitoring chart is inserted as the alternative processing, the alternative processing instruction unit 28 can causes the count to be reset and appropriately change the schedule so as to insert the color difference monitoring chart every specified number of sheets from after the alternative processing.

Further, as shown in FIG. 9 or FIG. 12, the image forming device 1 includes the operation display 11 which can prevent the color difference monitoring chart page from being changed.

According to such a configuration, the user can appropriately select an option not to change the color difference monitoring chart page by operating the operation display 11, as necessary.

Further, as shown in FIG. 2, FIG. 3, or FIG. 9, the alternative processing instruction unit 28 causes the image forming device 1 to interrupt printing for causing the image forming device 1 to execute the alternative processing for maintaining the image quality.

According to such a configuration, the alternative processing instruction unit 28 interrupts the printing of the image forming device 1 when the processing for maintaining the image quality is performed, which allows suppressing unnecessary printing.

Further, as shown in FIG. 3, if the image forming device 1 has an image stabilization function, the alternative processing instruction unit 28 can cause the image forming device 1 to execute the image stabilization as the alternative processing.

According to such a configuration, the alternative processing instruction unit 28 causes the image forming device 1 to perform the image stabilization as the alternative process, and which allows a stabilized image to be always printed.

Further, as shown in FIG. 2 or 3, the alternative processing instruction unit 28 causes the image forming device 1 to add a process each time the designated time of the RIP is exceeded.

According to such a configuration, the alternative processing instruction unit 28 causes the image forming device 1 to add an alternative processing or the like each time the designated time of the RIP is exceeded, so that it is possible to search for means for shortening the RIP time to shorten it.

Further, as shown in FIG. 2 or FIG. 3, when the number of printed sheets is smaller than that of the previously executed process, the alternative processing instruction unit 28 causes the image forming device 1 to change the process to another process.

According to such a configuration, when the number of printed sheets is smaller than that of the previously performed process, the alternative processing instruction unit 28 can search for an efficient process by changing the process to another process.

As shown in FIG. 3, when the RIP is delayed more than the designated number of times, the alternative processing instruction unit 28 instructs the image forming device 1 to perform the alternative processing that requires a longer processing time than that for the alternative processing instructed so far.

According to such a configuration, when a delay occurs more than the designated number of times, the alternative processing instruction unit 28 can execute a process for maintaining the image quality as the alternative processing of the page which takes a long processing time.

Next, when the RIP of the page is completed, printing is resumed after the alternative processing.
In this way, the user executes the processing for maintaining the image quality, and thereby the time until the RIP is completed can be used without waste.

Further, as shown in FIG. 2 or FIG. 12, the image forming device 1 includes an operation display 11 capable of designating in advance which alternative processing is to be executed.

According to such a configuration, because the user can designate in advance which alternative processing is to be executed by operating the operation display 11, the user can freely select various kinds of alternative processing, which is convenient.

Further, the alternative processing execution method of the present invention includes the steps of: performing RIP on print data by the RIP unit 21; instructing the image forming device 1 to print RIP data by the print instruction unit 23; detecting a page on which the RIP is delayed during on-the-fly printing in which printing is started without waiting for completion of the RIP of a print job by the delay detection unit 27; and causing the image forming device 1 to interrupt printing of the page and to execute alternative processing by the alternative processing instruction unit 28.

According to such a configuration, in the alternative processing execution method of the present invention, when the delay detection unit 27 detects a page for which the RIP is delayed, the alternative processing instruction unit 28 causes the image forming device 1 to interrupt printing of the page and to execute the alternative processing.

Therefore, the method of the present invention, when a delay occurs in the RIP, allows the image quality state confirmation processing, the image quality correction processing, or the maintenance processing to be executed instead, so that the waiting time of the RIP can be effectively utilized.
Thus, the present invention, when the RIP for a specific page is delayed and printing is interrupted during on-the-fly printing, makes it possible to utilize a waiting time until the RIP is completed and printing is resumed.

An alternative processing execution program of the present invention causes a computer to execute a sequence of performing RIP on print data, a sequence of instructing the image forming device 1 to print RIP data, a sequence of detecting a page on which the RIP is delayed during on-the-fly printing in which printing is started without waiting for completion of RIP of a print job, and a sequence of causing the image forming device 1 to interrupt printing of the page and to execute alternative processing.

In such a configuration, in the alternative processing execution program of the present invention, when the delay detection unit 27 detects a page for which the RIP is delayed, the alternative processing instruction unit 28 causes the image forming device 1 to interrupt the printing of the page and to execute the alternative processing.

Therefore, according to the present invention, when a delay occurs in the RIP, the image quality state confirmation processing, the image quality correction processing, and the maintenance processing are executed instead, so that the waiting time of the RIP can be effectively utilized.
Thus, the present invention, when RIP for a specific page is delayed and printing is interrupted during on-the-fly printing, allows utilizing a waiting time until the RIP is completed and resuming the printing.

### MODIFICATION EXAMPLE

Although the embodiment of the present invention is described above, the present invention is not limited to the above-described embodiment and can be appropriately modified without departing from the gist of the present invention.

For example, when the image forming device 1 illustrated in FIG. 2 is an inkjet machine, the image forming unit 12 includes an ink head and a wipe unit.

The ink head and the wipe unit needs to be periodically cleaned.
Therefore, the alternative processing instruction unit 28 (see FIG. 3) may instruct the image forming device 1 to perform parts cleaning as the alternative processing.
According to such a configuration, the alternative processing instruction unit 28 can improve an operation of the image forming device 1 by causing the image forming device 1 to execute the parts cleaning as the alternative processing.

In addition, the alternative processing shown in FIG. 6 and the processing at the time of RIP delay shown in FIG. 10 may execute head cleaning and wipe cleaning for parts cleaning as the alternative processing.

In this case, the alternative processing is executed after the printing (sheet feed and conveyance processing) is stopped.
The cleaning processing takes several minutes, and therefore, the RIP data of the remaining page can be generated during that time.
According to such a configuration, because the parts cleaning includes the head cleaning and the wipe cleaning, executing such a cleaning allows clear printing.

Furthermore, when the head cleaning or the wipe unit cleaning is executed as the alternative processing, the alternative processing instruction unit 28 preferably causes the image forming device 1 to cancel (skip) the next periodic cleaning.

In such a configuration, in a case in which the head cleaning or the wipe unit cleaning is executed as the alternative processing, the next periodic cleaning is cancelled, which makes it possible to efficiently perform the cleaning.

Further, the processing at the time of RIP delay shown in FIG. 5 and FIG. 10 may be replaced by the image stabilization as the alternative processing.

In this case, this alternative processing is executed after the printing (sheet feed and conveyance processing) is stopped.
Because the image stabilization takes several minutes, which time allows the RIP data of the remaining pages to be created.

Therefore, when the image forming device 1 is caused to perform the image stabilization as the alternative processing, the alternative processing instruction unit 28 (see FIG. 3) may cancel (skip) the next regularly scheduled image stabilization.

According to such a configuration, when the image stabilization is performed as the alternative process, the next regularly scheduled image stabilization can be cancelled, and thus the image stabilization can be efficiently and effectively performed.

In more addition, in a case in which the head cleaning, the wipe cleaning, and the image stabilization are executed as the alternative processing, considering only one job, its completion appears to be delayed; but considering a total use of the image forming device 1, there appears no difference to occur in the work completion time.

The present invention is not limited to the above-described embodiments and includes various modifications. The above-described embodiments are described in detail for easy understanding of the present invention, and the present invention is not limited to those having all or parts of the configurations described above. The scope of the invention should be interpreted in terms of the appended claims. Furthermore, a part of a configuration of an embodiment can be replaced with a configuration of another embodiment, and a configuration of an embodiment can be additionally provided with a configuration of another embodiment.

### REFERENCE SIGNS LIST

1: image forming device
2: controller
11: operation display
21: RIP unit
23: print instruction unit
27: delay detection unit
28: alternative processing instruction unit
100: image forming system

What is claimed is:

1. An image forming system comprising:
a raster image processing (RIP) processor configured to perform RIP on data to be printed;
a print instructor configured to instruct an image forming device to print RIP data;
a delay detector configured to detect a page for which the RIP is delayed during on-the-fly printing that starts printing without waiting for completion of the RIP of a print job; and
an alternative processing instructor configured to cause the image forming device to interrupt printing of the page and to execute an alternative processing.

2. The image forming system according to claim 1, wherein
the alternative processing instructor causes the RIP to be continued for the page for which the RIP is delayed and for pages subsequent to the page, while the alternative processing is in execution.

3. The image forming system according to claim 1, wherein
the alternative processing includes processing for monitoring maintenance of image quality and correction processing, when the monitoring or the correction is executed, printing by the image forming device is not interrupted.

4. The image forming system according to claim 1, wherein
the alternative processing instructor instructs the image forming device to perform nozzle deficiency detection as the alternative processing, and
the image forming device prints a nozzle deficiency detection chart to perform the nozzle deficiency detection.

5. The image forming system according to claim 4, wherein
the alternative processing instructor causes the image forming device to perform insertion-printing of the nozzle deficiency detection chart as the alternative processing, and to perform correction and then reprint a nozzle deficiency chart for confirmation when nozzle deficiency is detected.

6. The image forming system according to claim 4, wherein
in a case in which the nozzle deficiency detection chart is printed as the alternative processing in a job that is set to insert a nozzle deficiency detection chart for each specified number of sheets, the alternative processing instructor causes the image forming device to cancel an insertion page scheduled to be printed immediately thereafter.

7. The image forming system according to claim 4, wherein
in a case in which the nozzle deficiency detection chart is printed as the alternative processing in a job that is set to insert a nozzle deficiency detection chart at each specified number of sheets, the alternative processing instructor causes the image forming device to reset a count of insertion pages and change the job so as to insert the nozzle deficiency detection chart at each designated number of sheets from after the alternative processing.

8. The image forming system according to claim 1, wherein
the alternative processing instructor causes the image forming device to insert, as the alternative processing, a sample printing in which a same page as a previous printed page is reprinted and discharged to another tray.

9. The image forming system according to claim 8, wherein
the sample printing is inserted as the alternative processing in a job that is set to insert the sample printing at every specified number of sheets, the alternative processing instructor causes the image forming device to cancel an insertion page scheduled immediately thereafter.

10. The image forming system according to claim 8, comprising
an operation display that prevents an insertion page of the sample printing from being changed.

11. The image forming system according to claim 1, wherein
the alternative processing instructor causes the image forming device to insert a color difference monitoring chart as the alternative processing when color difference monitoring is set in a job.

12. The image forming system according to claim 11, wherein
the alternative processing instructor causes the image forming device to perform insertion-printing of the color difference monitoring chart as the alternative processing and to perform correction processing when a color difference is larger than a specified value in comparison with a color difference monitoring chart printed before a start of printing.

13. The image forming system according to claim 1, wherein
the alternative processing instructor causes the image forming device to interrupt printing when causing the image forming device to execute an alternative processing for maintaining image quality.

14. The image forming system according to claim 1, wherein
the alternative processing instructor causes the image forming device to perform parts cleaning as the alternative processing.

15. The image forming system according to claim 14, wherein
the parts cleaning includes head cleaning and wipe cleaning.

16. The image forming system according to claim 14, wherein
in a case in which the alternative processing instructor causes the image forming device to perform parts cleaning as the alternative processing, the alternative processing instructor can cause the image forming device to cancel a next regular cleaning.

17. The image forming system according to claim 1, wherein
in a case in which the image forming device has an image stabilization function, the alternative processing instructor causes the image forming device to perform image stabilization as the alternative processing.

18. The image forming system according to claim 1, wherein
the alternative processing instructor causes the image forming device to add the alternative processing each time a specified time for the RIP is exceeded.

19. An alternative processing execution method comprising:
executing RIP on data to be printed by an RIP processor;
instructing an image forming device to print RIP data by a print instructor;
detecting a page for which the RIP is delayed during on-the-fly printing that starts printing without waiting for completion of the RIP of a print job by a delay detector; and
causing the image forming device to interrupt printing of the page to execute an alternative processing by an alternative processing instructor.

20. A non-transitory computer-readable storage medium storing an alternative processing execution program for causing a computer to perform:
executing RIP on data to be printed;
instructing an image forming device to print RIP data;
detecting a page for which the RIP is delayed during on-the-fly printing that starts printing without waiting for completion of the RIP of a print job, and
causing the image forming device to interrupt printing of the page to execute an alternative processing.
